(19) United States
(12) Patent Application Publication
(10) Pub. No.: US 2025/0100257 A1
(43) Pub. Date: Mar. 27, 2025

(54) COMPOSITE MATERIAL SANDWICH STRUCTURE FOR VEHICLE COMPONENTS

(71) Applicant: Teijin Automotive Technologies, Inc., Auburn Hills, MI (US)

(72) Inventors: Hugh Foran, Auburn Hills, MI (US); Matt Plauman, Auburn Hills, MI (US); Evan Freeman-Gibb, Auburn Hills, MI (US); Patrick Durham, Auburn Hills, MI (US)

(73) Assignee: Teijin Automotive Technologies, Inc., Auburn Hills, MI (US)

(21) Appl. No.: 18/728,288

(22) PCT Filed: Jan. 9, 2023
(86) PCT No.: PCT/US2023/010372

§ 371 Date: Jul. 11, 2024

Related U.S. Application Data
(60) Provisional application No. 63/298,362, filed on Jan. 11, 2022.

(51) Int. Cl. B32B 27/12; B32B 3/12; B32B 5/02; B32B 5/18; B32B 5/24; B32B 7/12; B32B 27/06; B32B 27/20; B62D 29/04

(52) U.S. Cl. CPC B32B 27/12; B32B 3/12; B32B 5/024; B32B 5/18; B32B 5/245; B32B 7/12; B32B 27/06; B32B 27/20; B62D 29/043; B32B 2307/536; B32B 2307/7246; B32B 2307/7376; B32B 2605/08

(57) ABSTRACT

A vehicle cargo construct including a floor having an upper surface and an oppositely opposed lower surface, a plurality of side wall panels extending from the floor, and an end wall panel extending from the floor between the plurality of side wall panels. Each of the plurality of side wall panels and end wall panel having an exterior surface and an oppositely opposed interior surface. Each of the floor, the plurality of side wall panels, and the end wall panel being formed of a composite sandwich panel material that includes a core defining a plurality of pores, a surface sheet adhered to a first face of the core by a first adhesive layer, and a structural skin adhered to a second face of the core by a second adhesive layer.

### RELATED APPLICATIONS

This application claims priority benefit of U.S. Provisional Application Ser. No. 63/298,363, filed on Jan. 11, 2022, the contents of which are hereby incorporated by reference.

### FIELD OF THE INVENTION

The present invention in general relates to composite materials and in particular to a composite sandwich structure for forming vehicle components including cargo beds and pickup truck boxes, roofs, hoods, liftgates, and doors.

### BACKGROUND OF THE INVENTION

Weight savings in the automotive, transportation, and logistics based industries has been a major focus in order to make more fuel efficient vehicles both for ground and air transport. In order to achieve these weight savings, light weight composite materials have been introduced to take the place of metal structural and surface body components and panels. Composite materials are materials made from two or more constituent materials with significantly different physical or chemical properties, that when combined, produce a material with characteristics different from the individual components. The individual components remain separate and distinct within the finished structure. A composite material may be preferred for many reasons: common examples include materials which are stronger, lighter, or less expensive when compared to traditional materials. A sandwich-structured composite is a special class of composite material that is fabricated by attaching two thin but stiff skins to a lightweight but thick core. The core material is normally a low strength material, but its higher thickness provides the sandwich composite with high bending stiffness with overall low density.

While sandwich structures have previously been developed to provide strength and reduced weight, manufacturing, durability, and application specific challenges have limited the capabilities and uses of sandwich structures for vehicle components.

For example, the ability to obtain a vehicle exterior quality high gloss surface has remained a challenge, regardless of whether the surface outermost layer is thermoset resin or thermoplastic. Exemplary of these efforts are U.S. Pat. No. 5,087,500A; U.S. Pat. No. 4,803,108A; U.S. Pat. No. 8,091,286B2; U.S. Pat. No. 4,369,608A; U.S. Pat. No. 3,553,054A; and WO2018/202473. It is conventional to either not use such structures in settings where vehicle high surface gloss is required, or resort to an additional outer layer to provide a high gloss outermost layer. Such outermost layers can be applied after structure production or through in mold coatings, both of which add to the cost and complexity of production.

Still another problem conventional to the art is that structure edges are ineffective and allow for infiltration of humidity or moisture that becomes entrained within the core and often inconsistent with finished vehicle surface requirements. With temperature extremes this entrained moisture can reduce the operational lifetime of the structure, while increasing the weight thereof. These problems of moisture infiltration are particularly pronounced in instances when the core is formed of cellulosic materials such as paper. Attempts have been made to provide a core material that is formed of a plastic material instead of paper, but such materials have proven to be too expensive and complex to manufacture for such purposes.

Accordingly, such composite structures have been unsuitable for forming exterior facing vehicle components, such as truck beds and walls defining cargo compartments, roofs, hoods, liftgates, and doors, given that such areas of a vehicle are openly exposed to the elements, have exacting surface finish requirements, and must be resilient to typical use conditions for a given application.

In particular, lightweight and heavy duty trucks, such as pickups and sport utility vehicle have become increasingly popular for both business and personnel use. These vehicles are typically equipped with features and accessories to store and transport cargo, such as a generally horizontal truck bed and generally vertically oriented walls extending therefrom that together define a cargo compartment. As shown in FIG. 1, typical truck beds and walls defining cargo compartments 100 are integrally formed as part of the vehicle body 102, which is then fastened to the vehicle frame 104. Alternatively, as shown in FIG. 2, some typical truck beds and walls defining cargo compartments 100 are integrally formed with the vehicle frame 104 structure, separate from the body of the cab portion 106 of the vehicle. In both cases, typical truck beds and walls defining cargo compartments are formed of steel, in order to withstand the typical wear and tear exerted upon truck beds and walls defining cargo compartments.

In order to reduce the weight of components associated with truck beds and walls defining cargo compartments, attempts have been made to form truck beds and walls defining cargo compartments out of aluminum; however, such truck beds and walls defining cargo compartments are easily punctured by objects placed in the cargo compartments during ordinary use. To avoid such punctures, other scratches, or damage to the truck bed and walls defining cargo compartments resulting from usual pickup truck use, users typically install a robust polymeric liner within the cargo compartment to cover the steel or aluminum truck bed and walls defining cargo compartments. Such truck bed liners are an added expense to consumers, add to the weight of the vehicle, and reduce the usable space available within the cargo compartment.

Thus, there exists a need for a light weight yet robust composite sandwich structure for forming vehicle components that are openly exposed to the elements, have exacting surface finish requirements, and are resilient to typical use conditions for a given application. Furthermore, there exists a need for a sandwich composite structure that affords a high gloss surface without resort to additional processing after production or the addition of further outermost surface layers and for such sandwich composite structures with moisture resistance and well-trimmed edges as well as durability in the event that the interior of the sandwich structure is exposed to moisture.

### SUMMARY OF THE INVENTION

The present invention provides a vehicle cargo construct that includes a floor having an upper surface and an oppositely opposed lower surface, a plurality of side wall panels extending from the floor, and an end wall panel extending from the floor between the plurality of side wall panels. Each of the plurality of side wall panels and end wall panel having an exterior surface and an oppositely opposed interior surface. Each of the floor, the plurality of side wall panels, and the end wall panel being formed of a composite sandwich panel material that includes a core defining a plurality of pores, a surface sheet adhered to a first face of the core by a first adhesive layer, and a structural skin adhered to a second face of the core by a second adhesive layer.

### BRIEF DESCRIPTION OF THE DRAWINGS

The present invention is further detailed with respect to the following drawings that are intended to show certain aspects of the present invention but should not be construed as a limit on the practice of the present invention.

FIG. 1 is a schematic drawing showing a side view of a typical pickup truck in which the cargo compartment is integrally formed with the vehicle body;

FIG. 2 is a schematic drawing showing a side view of a typical pickup truck in which the cargo compartment is integrally formed with the vehicle frame;

FIG. 3 shows an exploded perspective view of an inventive vehicle cargo construct according to embodiments of the present invention;

FIG. 4 is a partial cutaway, perspective view of a composite sandwich panel material used to form embodiments of the inventive cargo construct;

FIG. 5 is an enlarged partial cutaway, side view of the composite sandwich panel material of FIG. 4 along a line bisecting the hexagonal pores;

FIGS. 6A-6D are cross-sectional views of edges of a composite sandwich panel material;

FIG. 7 is a partial cutaway, perspective view of a composite sandwich panel material having a conduit used to form embodiments of the inventive component construct;

FIG. 8 is a cross sectional view of a hard point at which a vehicle cargo construct is attached to a vehicle frame or chassis according to embodiments of the present disclosure;

FIG. 9 is a partial cutaway, perspective view of a composite sandwich panel material used to form embodiments of the inventive cargo construct;

FIG. 10 is an enlarged partial cutaway, side view of the composite sandwich panel material of FIG. 9;

FIG. 11 is a partial cutaway, perspective view of a composite sandwich panel material having a conduit used to form embodiments of the inventive component construct;

FIG. 12 shows a perspective view of an inventive roof assembly formed with an inventive composite sandwich structure according to embodiments of the present invention;

FIG. 13 shows a perspective view of an inventive hood assembly formed with an inventive composite sandwich structure according to embodiments of the present invention;

FIG. 14 shows a perspective view of an inventive liftgate assembly formed with an inventive composite sandwich structure according to embodiments of the present invention;

FIG. 15 shows a cross sectional view of an inventive unitary vehicle cargo construct according to embodiments of the present invention;

FIG. 16A shows a crosscar cross sectional view of a vehicle cargo construct according to embodiments of the present invention;

FIG. 16B shows a front to back cross sectional view of the vehicle cargo construct of FIG. 16A;

FIG. 17A shows a crosscar cross sectional view of a vehicle cargo construct according to embodiments of the present invention;

FIG. 17B shows a front to back cross sectional view of the vehicle cargo construct of FIG. 17A;

FIG. 18A shows a crosscar cross sectional view of a vehicle cargo construct according to embodiments of the present invention;

FIG. 18B shows a front to back cross sectional view of the vehicle cargo construct of FIG. 18A;

FIG. 19A shows a crosscar cross sectional view of a vehicle cargo construct according to embodiments of the present invention;

FIG. 19B shows a front to back cross sectional view of the vehicle cargo construct of FIG. 19A;

FIG. 20 is a graph showing maximum payloads versus deflection;

FIG. 21 is a graph showing maximum payload versus weight of an 8 foot pickup box; and

FIG. 22 is a graph showing maximum payload versus investment cost.

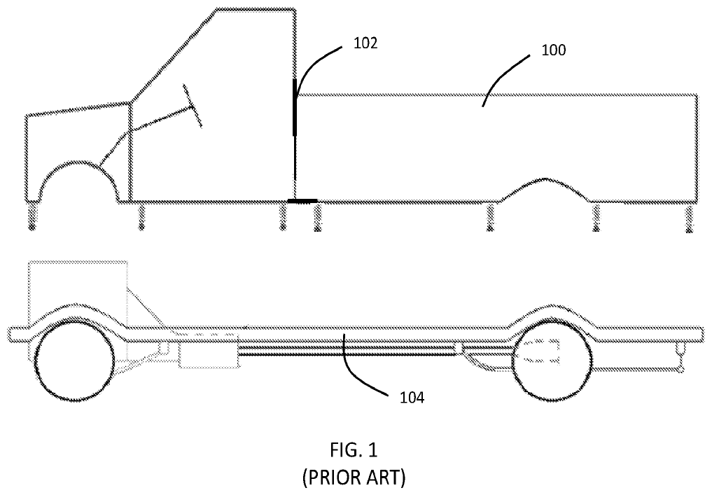

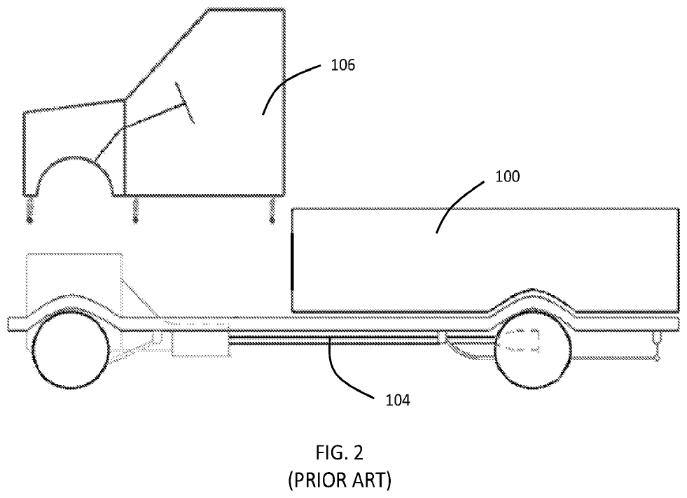

### DESCRIPTION OF THE INVENTION

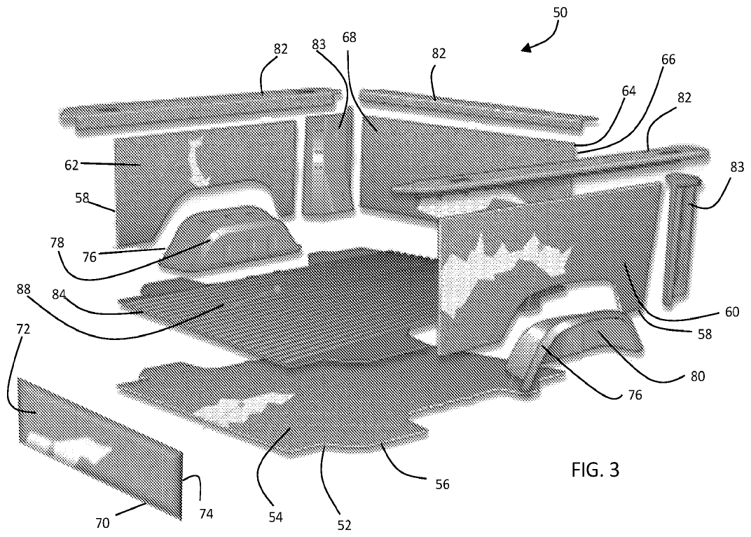

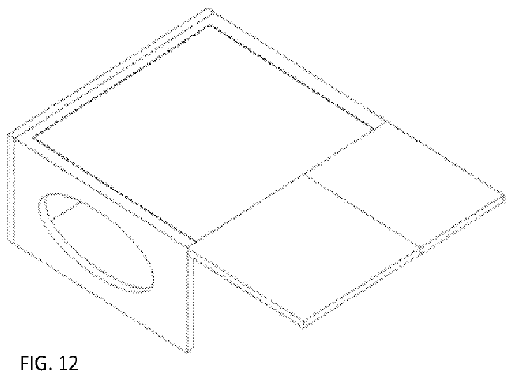

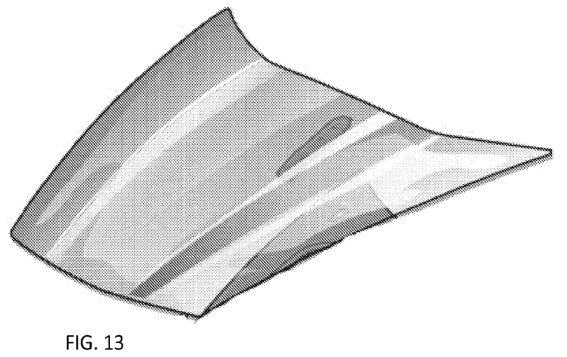

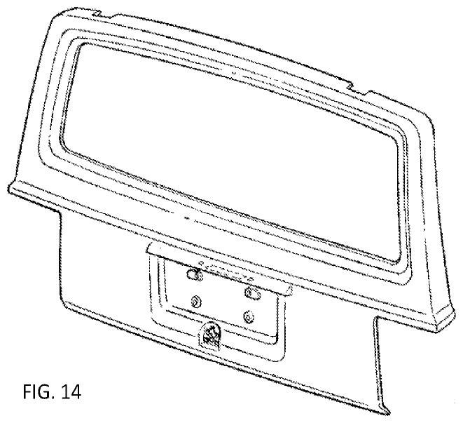

The present invention has utility as a composite sandwich panel structure 10 with a core 12 sandwiched between a high gloss surface sheet 14 and a structural skin 16 that are adhered to the core so as to reduce delamination of the formed part. The composite sandwich panel structure 10 is well suited for forming vehicle components including vehicle cargo bed and pickup truck boxes, roofs, doors, hoods, and liftgates, as shown in FIGS. 3 and 12-14 and described in further detailed in U.S. patent application Ser. No. 17/420,160, U.S. patent application Ser. No. 17/618,176, and U.S. patent application Ser. No. 17/618,139, the contents of which are hereby incorporated by reference. It is appreciated that the high gloss surface sheet 14 is readily formed with a mold platen that confers a surface texture simulative wood grain, or other surface that is both decorative and provides additional friction upon contacting the surface. Such surfaces being particularly favored in the floor of a pick-up truck bed liner. In still other embodiments, the sheet 14 is replaced with another structural skin 16 (not shown) so as to create a sandwich between two opposing structural skins 16 that join at the edges to isolate the core 12 from the exterior. In other embodiments in which the sheet 14 or skin 16 is not overcoated and thus potential exposed to solar radiation, the composition from which the sheet 14 or skin 16 is formed includes an ultraviolet light stabilizer.

Suitable UV absorbing additives include for example, hydroxybenzophenones; hydroxybenzotriazoles; hydroxybenzotriazines; cyanoacrylates; oxanilides; benzoxazinones; 2-(2H-benzotriazol-2-yl)-4-(1,1,3,3-tetramethylbutyl)-phenol (CYASORB™ 5411); 2-hydroxy-4-n-octyloxybenzophenone (CYASORB™ 531); 2-[4,6-bis(2,4-dimethylphenyl)-1,3,5-triazin-2-yl]-5-(octyloxy)-phenol (CYASORB™ 1164); 2,2′-(1,4-phenylene)bis(4H-3,1-benzoxazin-4-one) (CYASORB™ UV-3638); 1,3-bis[(2-cyano-3,3-diphenylacryloyl)oxy]-2,2-bis[[(2-cyano-3,3-diphenyl-acryloyl)oxy]methyl]propane (UVINUL™ 3030); 2,2′-(1,4-phenylene)bis(4H-3,1-benzoxazin-4-one); 1,3-bis[(2-cyano-3,3-diphenylacryloyl)oxy]-2,2-bis[[(2-cyano-3,3-diphenyl-acryloyl)oxy]methyl]propane, nano-size inorganic materials such as titanium oxide, cerium oxide, and zinc oxide, all with particle size less than about 100 nanometers; or the like, or combinations comprising at least one of the foregoing UV absorbers. UV absorbers are generally used in amounts of about 0.1 to about 5 parts by weight, based on 100 parts by weight of the polymeric components of the polymeric composition.

According to particular embodiments, such as in FIG. 3, the present invention has utility as a light weight yet robust vehicle cargo bed and pickup truck box formed with a composite core sandwich structure capable of withstanding typical wear and tear and environmental elements experienced by truck cargo compartments. The use of the composite sandwich structure allows for replacement of traditional materials such as steel or aluminum, without a loss of strength, in a vehicle's cargo bed or pickup truck box while also reducing the overall weight of the vehicle. Additionally, the present invention has utility as components for forming a cargo bed or pickup truck box structure having a high gloss surface suitable for the vehicle exterior and having an opposite robust surface suitable for lining a truck cargo compartment, while being a high strength and light weight vehicle component.

According to embodiments, the sandwich composite structure provides a high gloss surface sheet and structural skin that are adhered to the core with an adhesive or glue that is viscous when applied. The viscosity of the adhesive as applied allows for contact with the interior volume of the core to create more adhesion surface area yet without excessively running into the pores defined in the core before the adhesive cured or hardens thereby providing greater adhered contact area between the components of the sandwich composite structure. As a result, reduced delamination of the components of the sandwich composite structure is observed as well as precluding bond line readthrough into the high gloss surface sheet. It is appreciated that providing a high gloss exterior surface without resort to an additional outmost layer requires a balancing of opposing surface tension properties of the composite sandwich panel structures to avoid a loss in tolerances associated with bowing of the structure. Embodiments of the present invention also have utility as watertight and waterproof composite sandwich panel structures.

The present invention will now be described with reference to the following embodiments. As is apparent by these descriptions, this invention can be embodied in different forms and should not be construed as limited to the embodiments set forth herein. Rather, these embodiments are provided so that this disclosure will be thorough and complete, and will fully convey the scope of the invention to those skilled in the art. For example, features illustrated with respect to one embodiment can be incorporated into other embodiments, and features illustrated with respect to a particular embodiment may be deleted from the embodiment. In addition, numerous variations and additions to the embodiments suggested herein will be apparent to those skilled in the art in light of the instant disclosure, which do not depart from the instant invention. Hence, the following specification is intended to illustrate some particular embodiments of the invention, and not to exhaustively specify all permutations, combinations, and variations thereof.

It is to be understood that in instances where a range of values are provided that the range is intended to encompass not only the end point values of the range but also intermediate values of the range as explicitly being included within the range and varying by the last significant figure of the range. By way of example, a recited range of from 1 to 4 is intended to include 1-2, 1-3, 2-4, 3-4, and 1-4.

Unless otherwise defined, all technical and scientific terms used herein have the same meaning as commonly understood by one of ordinary skill in the art to which this invention belongs. The terminology used in the description of the invention herein is for the purpose of describing particular embodiments only and is not intended to be limiting of the invention.

Unless indicated otherwise, explicitly or by context, the following terms are used herein as set forth below.

As used in the description of the invention and the appended claims, the singular forms “a,” “an” and “the” are intended to include the plural forms as well, unless the context clearly indicates otherwise.

Also as used herein, “and/or” refers to and encompasses any and all possible combinations of one or more of the associated listed items, as well as the lack of combinations when interpreted in the alternative (“or”).

As used herein, the term “high gloss surface” refers to a surface having minimal perceptible surface defects when visually inspected for about three seconds from about 24-28 inches from the viewer and normal to the part surface +/−90 degrees in a well-lit area. That is, the term “high gloss surface” refers to a surface capable of being painted and accepted as a “Class A” autobody part. This is commonly measured by ASTM D523. In the automotive industry, a Class A surface is a surface a consumer can see without functioning the vehicle (e.g., opening the hood or decklid), while a Class A surface finish generally refers to painted outer panels and specifically to the distinctness of image (DOI) and gloss level on the part. It is appreciated that a surface layer may be subjected to sanding, trimming, and priming prior to receiving a paint coating that imparts high gloss, yet must retain dimensionality and adhesion uniformity to primer and paint so as to achieve a high gloss finish.

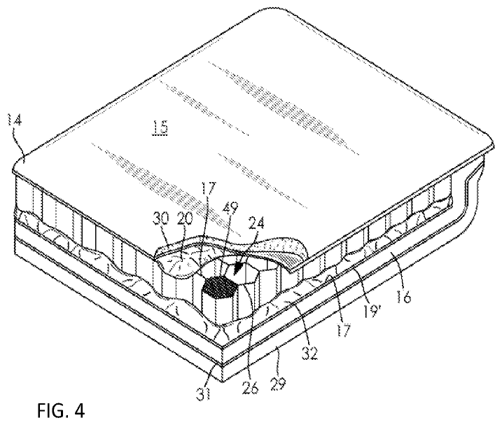

FIG. 3 shows an exploded perspective view of an inventive vehicle cargo construct 50 according to embodiments of the present invention. According to embodiments, the vehicle cargo construct 50 includes a floor 52, a plurality of side wall panels 58 extending from said floor 52, and an end wall panel extending 64 from said floor 52 between the side wall panels 58. The floor 52 has an upper surface 54 and an oppositely opposed lower surface 56. Each of the side wall panels 58 has an exterior surface 60 and an oppositely opposed interior surface 62. The end wall panel 64 has an exterior surface 66 and an oppositely opposed interior surface 68. According to embodiments, the floor 52, the side wall panels 58, and the end wall panel 64 are formed of a composite sandwich panel material 10, such as that shown in FIGS. 4-11.

The composite sandwich panel material 10 includes a core 12. According to embodiments, the core 12 is a pre-cut piece of a polymeric foam material. The polymeric foam in some inventive embodiments is a closed-cell foam. Typical foam hardness values range from J to B on the pencil hardness scale. Suitable polymers from which such foam material is formed illustratively include polyurethane, polyurea, ethyl-vinyl acetate, polypropylene, polyethylene, polystyrene, polycarbonate, polyvinyl chloride, polylactic acid, silicone, polycarbonate, microcellular material, and combinations thereof. The core 12 terminates in faces 17 and 17′, a surface sheet 14 adhered to a first face 17 of the core 12 by a first adhesive layer 20, and a structural skin 16 adhered to a second face 17′ of the core 12 by a second adhesive layer 22.

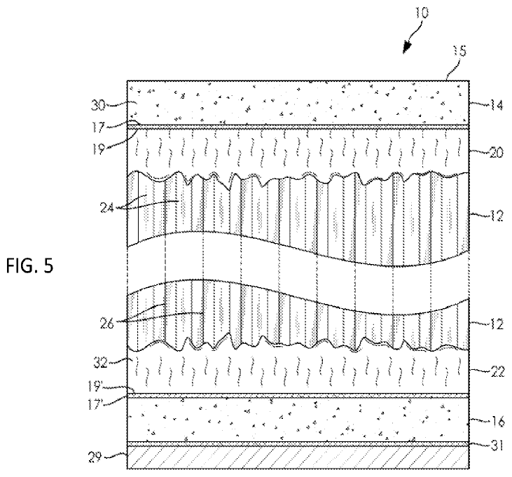

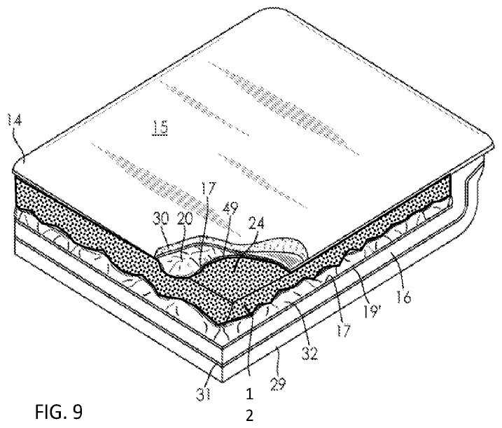

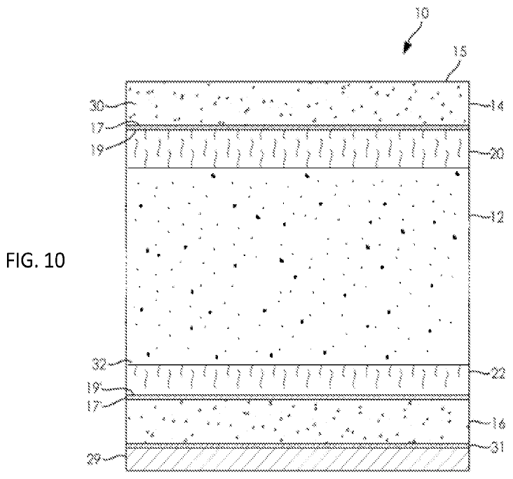

As shown in FIGS. 4 and 9, a portion of the surface sheet 14 is cutaway to reveal the adhesive 20, a cloth, if present; and the core 12. The surface sheet 14 is adhered to a first side of the core 12 by a first adhesive layer 20. According to embodiments, the surface sheet 14 presents an outwardly facing high gloss surface 15. FIGS. 5 and 10 show enlarged cross-sectional views of a composite sandwich panel material 10 used to form the inventive cargo construct 50 according to embodiments of the invention. FIGS. 5 and 10 show further details of the various layers making up the composite sandwich panel material 10. In some embodiments, a cloth 19 is present intermediate between the face 17 of the core 12 and the surface sheet 14, the cloth 19 being embedded within the adhesive 20. The structural skin 16 is adhered to an opposing second side of the core 12 by a second adhesive layer 22. In some embodiments, a cloth 19′ is present intermediate between the face 17′ of core 12 and the structural skin 16, the cloth 19′ being embedded within the adhesive 22.

According to embodiments, the core 12 is formed of a lightweight material that defines a plurality of pores 24 so as to reduce the overall density of the core 12. The core 12 is formed from a variety of materials that include cellulosics such as corrugated fiberboard, paper board, paper stock; thermoplastics such as poly (methyl methacrylate) (PMMA), acrylonitrile butadiene styrene (ABS), polyamides, polylactides, polybenzimidazoles, polycarbonates, polyether sulfones, polyethylene, polypropylene, polystyrene, polyvinyl chloride, and block copolymers of any one of the aforementioned where at least one of the aforementioned makes up the majority by weight of the copolymer and regardless of the tacticity of the polymer or copolymer; thermosets such as polyesters, polyureas, polyurethanes, polyurea/polyurethanes, epoxies, vinyl esters; metal such as aluminum, magnesium, and alloys of any one of the aforementioned where at least one of the aforementioned metals constitutes the majority by weight of the alloy; a foam formed from polyurethane, polyethylene, ethylene vinyl acetate, polypropylene, polystyrene, polyvinyl chloride, oraerogels, regardless of whether the foam is open-celled or closed-celled. In FIG. 5, the core 12 is formed of an open area core 12 having a plurality of walls 26 that define pores 24 arranged in a patterned array. In FIG. 10, the core 12 is formed of a foam having a plurality of pores 24. The foam may be an open-cell foam or a closed-cell foam.

The adhesive layers 20, 22 are formed of either a thermoplastic or curable formulation, a polyurethane or polyurethane prepolymer adhesive, which may be in the form of glue, a moisture cure adhesive, a reactive hot melt adhesive, or a polyurethane resin. As shown in FIGS. 5 and 10, due to the compressive force applied to the adhesive layers 20, 22 between the surface sheet 14 and the core 12 and the structural skin 16 and the core 12, the adhesive 20, 22 is engineered to have an initial viscosity on contact with the face 17 so as partially fill the pores 24 of the core 12. The viscosity of the adhesive layers 20, 22 ensures that the adhesive does not excessively run into the pores defined in the core before the adhesive attains final strength. Accordingly, the adhesive surface area for adhesion between a surface sheet and structural skin and the core is at least 5% more than the surface area of the face. This increased surface area of adhesion reduces delamination of the components of the composite sandwich 10 and surprisingly allows for the use of thinner surface sheets that do not exhibit bond line read through. As a result of increasing the adhesive surface area coverage from 10 to 50 surface areas percent allows for the comparatively expensive high gloss surface sheet to be reduced in thickness from 1.5 mm to between 1.3 and 0.8 mm while still preventing of bond line read through.

The surface sheet 14 of the composite sandwich panel 10 is formed from sheet molding compound (SMC), thermoplastic, dicyclopentadiene (DCPD), overmolded polyurethane (PU), or a combination thereof. According to embodiments, the surface sheet 14 is a high gloss surface sheet having a high gloss surface 15. The surface sheet 14 can include a filler material 30 to reinforce and/or serve to decrease the weight of the high gloss surface sheet 14. The filler material 30 is any of glass fibers, carbon fibers, natural fibers, hollow or solid glass microspheres, or a combination thereof. According to embodiments, the filler material is present in an amount of 45 to 65% of the surface sheet material. The fibers may be oriented or non-oriented. In some inventive embodiments in which SMC forms the high gloss surface, a resin package sold by Continental Structural Plastics, Inc. under the tradenames TCAR and TCAR ULTRA-LITE™ are used herein. Exemplary formulations of which are detailed in U.S. Pat. No. 7,700,670; WO2017/184761; and U.S. Pat. No. 7,524,547B2. It is appreciated that the high gloss sheet routinely includes additives to retain dimensionality. Such additives routinely including glass fiber; carbon fiber; inorganic particulate fillers such as calcium carbonate, talc, and carbon black; glass microspheres; carbon nanotubes; graphene; low profile additives; moisture scavengers; and combinations thereof. Typical thicknesses of the high gloss surface sheet in the present invention range from 0.5 to 5 millimeters (mm) without regard to edges. According to embodiments the surface sheet 14 has a flexural modulus of 8.6 to 14.6 GPa. According to embodiments, the surface sheet 14 has a tensile modulus of 11 to 19.4 GPa. According to embodiments, the surface sheet 14 has a flexural strength of 261 to 368 MPa. According to embodiments, the surface sheet 14 has a tensile strength of 150 to 287 MPa.

As will be understood by a person having ordinary skill in the art, the high gloss surface sheet tends to be a comparatively dense component and an expensive portion to manufacture given the materials used and necessary forming processes to maintain minimal perceptible surface defects suitable for a Class A autobody part. To reduce costs and weight of the composite sandwich panel material 10, it is accordingly desirable to reduce the thickness of the high gloss surface sheet 14, making it as thin as possible. It will also be understood that as the thickness of the high gloss surface sheet 14 is decreased the high gloss surface sheet 14 tends to deform when supported by limited portions of the face 17 above the core 12. While resort to a large contact surface area of the first adhesive layer 20 is advantageous, in some inventive embodiments a cloth 19 is embedded in the first adhesive layer 20.

The structural skin 16 is adhered to the second side of the core 12 by the second adhesive layer 22. The structural skin 16 is formed of a fiber mat having non-oriented, non-woven fibers, unidirectional, or woven fibers, a thermoplastic sheet, or an SMC. The structural skin 16 provides a robust and durable surface. In some embodiments, the structural skin 16 terminates against the backside of the surface sheet 14 to encapsulate the core 12.

According to certain embodiments, the composite sandwich panel material 10 provides sound damping, fire retardancy, thermal insulation, or a combination thereof by use of a foam core 12 and/or by placing a sound and/or heat absorbing material within the pores 24 of the core 12. According to embodiments, the pores 24 of the core 12 are at least partially filled with a fill 49. The fill illustratively including foam pellets, fire retardant, or a phase change material. Phase change materials operative herein include waxes or an inorganic salt hydrates.

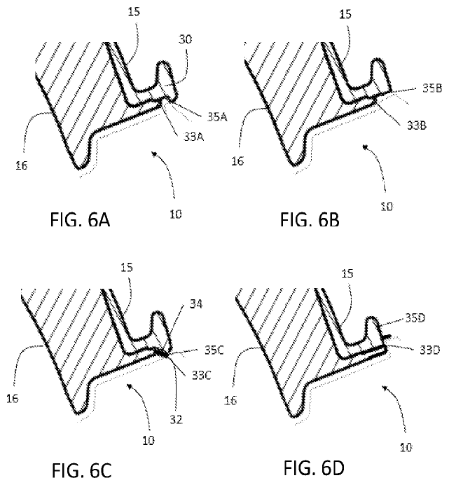

The surface sheet 14 and the structural skin 16 are joined together along an edge 33A-33D of the composite sandwich panel material 10 to form a seal, as shown in FIGS. 6A-6D, respectively. In certain embodiments in which all of the edges of the composite sandwich panel assembly 10 are sealed, the core 12 is fully enclosed and moisture is inhibited from entering the interior of the composite sandwich panel assembly 10. Given that the components of the inventive cargo construct 50 formed of the composite sandwich panel assembly 10 are exposed to natural elements including sun, snow, humidity, and rain, preventing moisture from entering the interior of the composite sandwich panel material 10 is important given that freeze thaw cycles of moisture within the part cause expansion and potentially failure of the composite sandwich panel material 10, leading to damage to the vehicle cargo construct 50. However, given that the core 12 is formed of a polymeric foam, according to embodiments, moisture penetration into the interior of the sandwich structure 10 is less of a concern as compared to embodiments where the core 12 is formed of a hydrophilic material such as paper.

FIGS. 6A-6D show various embodiments of ways in which the surface sheet 14 and the structural skin 16 are joined together to form a sealed edge 33A-33D, respectively according to the present disclosure. In some inventive embodiments an elastomeric gasket 34 is disposed between the surface sheet 14 and the structural skin 16 at the 33C to make the edge 33C more water resistant. It is appreciated that a gasket is readily included in the other edge joinder 33A, 33B, and 33D. The gasket 35 enhances maintenance of the edge seal over a wider range of use conditions.

As will be understood by one having ordinary skill in the art, to form an edge seal between the surface sheet 14 and the structural skin 16, at least one of the surface sheet 14 and the structural skin 16 requires enough material to wrap around the edge of the composite sandwich 10. According to embodiments, at least one of the surface sheet 14 and the structural skin 16 is provided in dimensions greater than the dimensions of the final composite part such that the material is able to wrap around the final edge composite sandwich 10. According to certain embodiments, the at least one of the surface sheet 14 and the structural skin 16 is preformed such that it has edges extending generally perpendicularly from the plane of the sheet material.

According to embodiments, excess material is cut from the composite sandwich once the edge seal is formed. As shown in FIG. 6A, excess material of the structural skin 16 has been trimmed from the composite sandwich assembly 10 by a knife or router that presses against the divot 35A that is formed by the surface sheet 14. In FIG. 6B, the edge 33B formed by removing excess material for tool engagement against a shoulder 35B of the surface sheet 14. In FIG. 6C, the edge 33C formed by removing excess material for tool engagement against a shoulder 35C of the surface sheet 14. Also, as shown in FIG. 6D, excess material of one or both the surface sheet 14 and the structural skin 16 are trimmed with tool pressure against shoulder 35D.

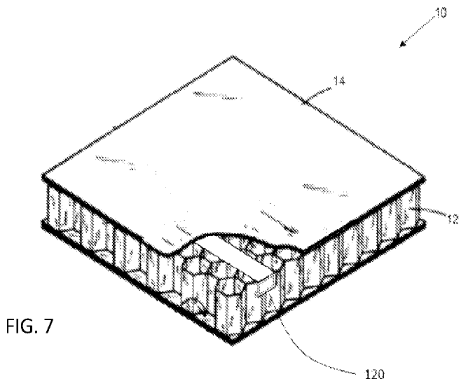

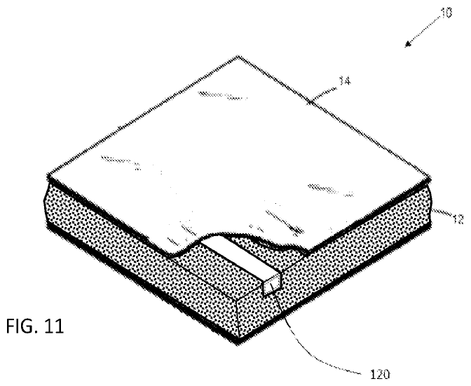

As shown in FIGS. 7 and 11, embodiments of an inventive vehicle cargo construct 50 include a conduit system 120 embedded within the composite sandwich panel material 10 of the vehicle component. As shown in FIGS. 7 and 11, the conduit system 120 is embedded in the core 12 of composite sandwich panel assembly 10 that forms the vehicle cargo construct 50. According to embodiments, the conduit system 120 comprises tubing or wires that are molded into the core 12 of the composite sandwich 10 before the vehicle component is formed. According to embodiments, the conduit system 120 includes electrical wiring, ventilation ducts, or heating elements. Accordingly, embodiments of the inventive vehicle cargo construct 50 are capable of including features such as speakers, lights, air vents, and defrosting elements for removing ice or snow present on the vehicle cargo construct 50. The conduit systems 120 of various vehicle components are configured to align with one another to form a single connected conduit system throughout the vehicle to connect electrical wiring, ventilation ducts, and/or heating elements of each of an inventive vehicle cargo construct with like electrical wiring, ventilation ducts, and/or heating elements of the vehicle to function.

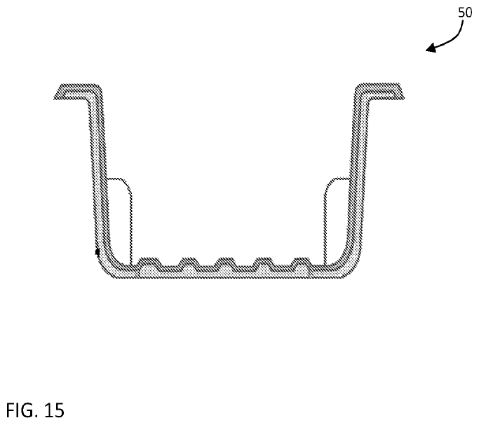

According to embodiments, the floor 52, the side wall panels 58, and the end wall panel 64 of the vehicle cargo construct 50 are integrally formed of a single piece of composite sandwich panel material 10 or each piece is formed of a separate piece of composite sandwich panel material 10. According to embodiments, the vehicle cargo construct 50 is a single unitary construct that is configured to be attached to a vehicle, as shown in FIG. 15. Alternatively, the vehicle cargo construct 50 is formed a several separate pieces that are configured to be joined together and to a vehicle frame, as shown in FIG. 3. In instances in which the vehicle cargo construct 50 is formed of a single piece of composite sandwich panel material 10, the cargo construct 50 is formed by folding the side walls 58 and the end wall 64 up from the plane of the floor 54. According to embodiments, the folding includes crushing portions of the composite sandwich panel material 10, particularly the core 12 along the fold lines.

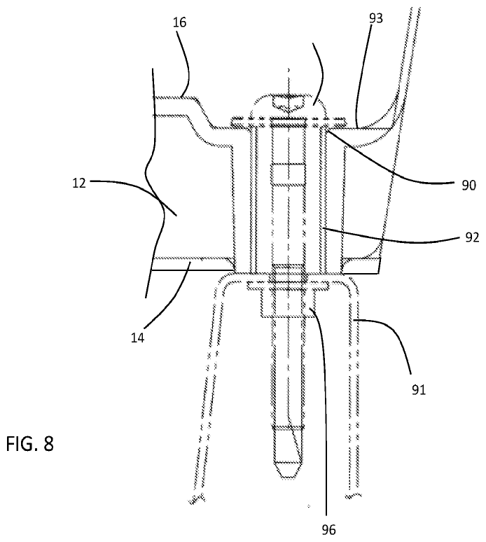

According to embodiments, the floor 52, the side wall panels 58, and/or the end wall panel 64 of the vehicle cargo construct 50 include a plurality of hard points 90, as shown in FIG. 8. The hard points 90 are configured to be points at which the vehicle cargo construct 50 is attached to the vehicle frame or chassis 91. According to embodiments, the hard points 90 are through holes defined in the composite sandwich panel material 10 that forms the vehicle cargo construct 50. According to embodiments, a fastener, such as a bolt 94, is inserted through the hard point 90 and through an opening defined in the vehicle frame 91, securing the vehicle cargo construct 50 to the vehicle frame 91 using a nut 96. According to embodiments, the hard points 90 are formed in mounting recesses 93 that are formed in the structural skin surface of the composite sandwich panel material 10, thus allowing the head of the fastener 94 to be recessed into the mounting recess 93 so that the head of the fastener 94 is flush with the surface of the cargo compartment that is defined by the structural skin 16 of the composite sandwich panel material 10. According to embodiments, the hard points 90 include a collar 92 disposed within the through hole that forms the hard point 90. The collar 92 may be inserted into the through hole defined by the composite sandwich panel material 10 after the through hole is formed in the composite sandwich panel material 10 or the collar 92 may be pre-positioned and the composite sandwich panel material 10 formed around the collars 92.

According to embodiments, the lower surface 56 of the floor 52 is defined by the surface sheet 14 of the composite sandwich panel material 10 and the oppositely opposed upper surface 54 of said floor 52 is defined by the structural skin 16 of the composite sandwich panel material 10. According to embodiments, the exterior surface 60 of each of the side wall panels 58 is defined by the surface sheet 14 of the composite sandwich panel material 10 and the oppositely opposed interior surface 62 of each of the side wall panels 58 is defined by the structural skin 16 of the composite sandwich panel material 10. According to embodiments, the exterior surface 66 of the end wall panel 64 is defined by the surface sheet 14 of the composite sandwich panel material 10 and the oppositely opposed interior surface 68 of the end wall panel 64 is defined by the structural skin 16 of the composite sandwich panel material 10. As noted above, in embodiments surface sheet 14 of the composite sandwich panel material 10 is a high gloss surface sheet with a high gloss finish 15 with minimal perceptible surface defects suitable for a Class A autobody part. Accordingly, in some embodiments the exterior surface 60 of each of the side wall panels 58 is a high gloss surface sheet 14.

According to embodiments, the upper surface 54 of the floor 52, the interior surface 62 of each of the side walls 58, and the interior surface 68 of the end wall 64 define a cargo compartment within the vehicle cargo construct 50. Given that these surfaces are defined by the structural skin 16 of the composite sandwich panel 10, these surfaces that define the cargo compartment are high strength, robust, and resistant to scratches, punctures, and other damage.

According to embodiments, the vehicle cargo construct 50 additionally includes a second end wall panel 70 extending from the floor 52 between the side wall panels 58. According to embodiments the second end wall panel 70 is formed a separate piece of the composite sandwich panel 10. The second end wall panel 70 has an exterior surface 72 and an oppositely opposed interior surface 74. According to embodiments, the exterior surface 72 of the second end wall panel 70 is defined by the surface sheet 14 of the composite sandwich panel material 10 and the oppositely opposed interior surface 74 of the second end wall panel 70 is defined by the structural skin 16 of the composite sandwich panel material 10. According to embodiments, the surface sheet 14 has a high gloss surface 15, thus the exterior surface 72 of the second end wall panel 70 has a finish that is suitable for a vehicle exterior. According to embodiments, the second end wall panel 70 is a tailgate attached to the floor 52 by a hinge. Thus, the second end wall panel 70 is configured to pivot about the hinge to open and close the end of the containment construct 50, thereby allowing a user access to the cargo compartment within the vehicle cargo construct 50 when the tailgate 70 is in its open position, and enclosing the cargo compartment within the vehicle cargo construct 50 when the tailgate 70 is in its closed position.

According to embodiments, any of the side wall panels 58 and/or the end wall panels, 64, 70 are formed of a double wall of composite sandwich panel material 10. In such embodiments, a void may be formed between the two walls of composite sandwich panel material 10. Within such a void, at least one compartment for housing various items is formed. The compartment may have a locking door formed in either one or both of the surrounding walls of composite sandwich panel material 10. Accordingly, items such as tools may be securely stored within the vehicle cargo construct 50.

According to embodiments, the vehicle cargo construct 50 additionally includes a plurality of wheel wells 76 each having an interior surface 78 and an exterior surface 80. Each of the wheel wells 76 configured to receive a wheel of the vehicle on the side of the exterior surface 80 of the wheel well 76 and partially surround the wheel of the vehicle. According to embodiments, the plurality of wheel wells 76 are defined by and are integrally formed with each of the side wall panels 58. Alternatively, the wheel wells 76 are structures formed separately from the side wall panels 58. Each of the wheel wells 76 is positioned between one of the side wall panels 58 and the floor 52.

According to embodiments, the vehicle cargo construct 50 additionally includes a plurality of cap sections 82 positioned along an upper edge of any or all of the side wall panels 58, the end wall panel 64, and the second end wall panel 70. According to embodiments, the cap sections 82 are formed of the composite sandwich panel material 10. The cap section 82 may be integrally formed with the panel from which it extends or may be formed of a separate piece of composite sandwich material 10 that is then attached to the corresponding panel to form the vehicle cargo construct 50.

According to embodiments, the vehicle cargo construct 50 additionally includes a plurality of shoulders 83. The shoulders 83 are configured to join and/or cover the corner edges of the wall sections 58, 64. The shoulders 83 may be positioned within the cargo construct or may be on the exterior side of the cargo construct 50. According to embodiments, the vehicle cargo construct 50 additionally includes a c-shaped outer frame positioned along the edges of the floor 52 and walls 58, 64. The c-shaped outer frame provides increased rigidity at the edges to further strengthen the cargo construct 50.

As shown in FIG. 3, embodiments of the vehicle cargo construct 50 include a bed liner 84 positioned on the upper surface 54 of the floor 52 of the containment construct 50. According to embodiments, the bed liner 50 is formed of the composite sandwich panel material 10. According to embodiments, the bed liner 84 is removable from the cargo construct 50 such that the bed liner 84 may be removed, easily washed, or replaced.

According to embodiments, the vehicle cargo construct 50 includes a plurality of break lines 88 or corrugations formed in the floor 52, the side wall panels 58, the end wall panels 64, 70, the cap sections 82, the be liner 84, the wheel wells 76, or a combination thereof. Such break lines 88 provide a predetermined crumple path in the event of an impact so that the composite sandwich panel material 10 of each part crumples and absorbs impact energy. According to embodiments, the break lines 88 are formed by crushing or pre-cutting the core 12 of the composite sandwich panel material 10 in pre-determined locations.

The vehicle cargo construct of the present invention is capable of supporting light, medium and heavy duty payloads. That is, a light and medium duty pickup box payload is typically between 773 and 1408 kg, while a medium to heavy duty pickup box payload is typically between 762 and 1976 kg. The present invention is capable of supporting these payloads.

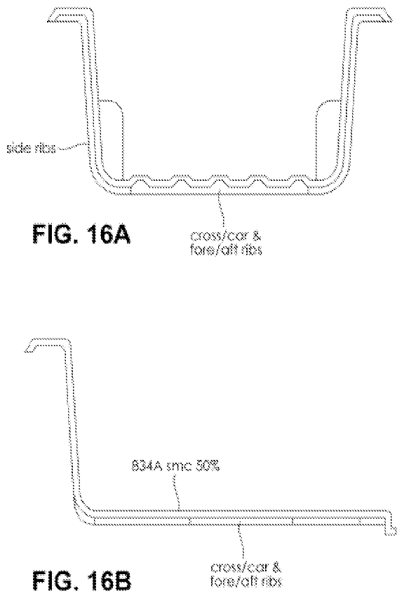

Embodiments of the inventive vehicle cargo construct provide numerous benefits including providing a grain or pattern on the floor of the pickup box, the ability to provide molded in features such as pockets and support boards, UV stability without the use of pain, resistance to corrosion and chemicals, weight reduction of about 20-30% overall, no visible spot welds or seams, resistance to impacts, dents, and scratches, no need to use an additional bed liner (which results in a savings for the consumer), ease of cleaning, a covered D-pillar so there is no exposed metal material that could otherwise rust, reduced insurance claim repair costs given that repairs require less time and expense, improved assembly tolerance from about +/−6 mm to +/−2 mm crosscar, reduced tooling costs for manufacturers, and higher resale value and long term appearance. FIGS. 16A-19B show various cross sectional view of an inventive vehicle cargo construct according to various embodiments of the present invention.

FIGS. 16A and 16B show an embodiment of a light to medium duty cargo construct. The cargo construct shown is formed of a single wall SMC construction and includes molded in ribs and features in the floor channels for added stiffness. This is a seamless box that mounts to a vehicle frame. Such a construction is configured to support up to 907 kg of payload while only weighing 41.7 kg itself.

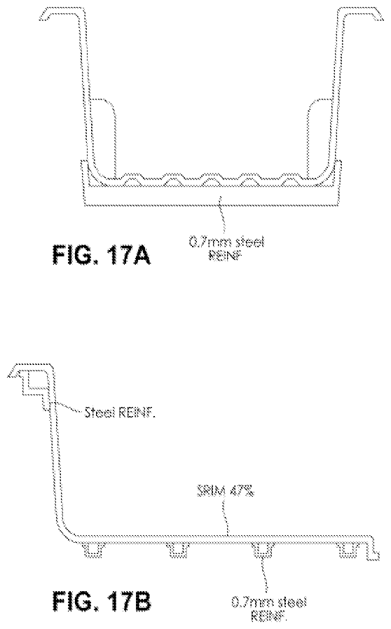

FIGS. 17A and 17B show an embodiment of a light to medium duty cargo construct. The cargo construct shown is formed of a single wall SMC construction and includes floor channels for added stiffness. This is a seamless box. The construct includes underbox steel roll formed reinforcements that mount to the frame of the vehicle. An additional steel reinforcement may be used to support upper regions of the SMC box. Such a construction is configured to support up to 1497 kg of payload while only weighing 45.4 kg itself.

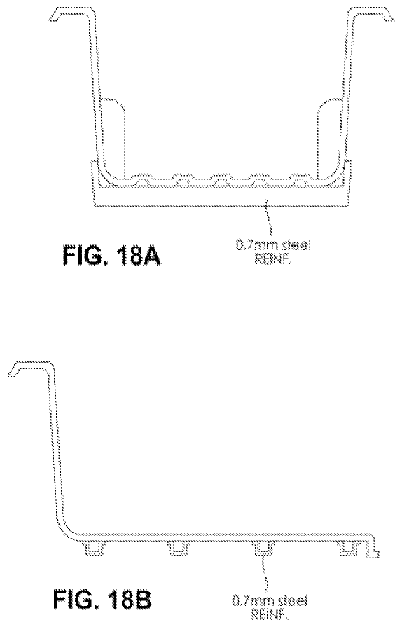

FIGS. 18A and 18B show an embodiment of a heavy duty cargo construct. The cargo construct shown is formed of a single wall SMC construction and includes floor channels for added stiffness. This is a seamless box. The construct includes underbox steel roll formed reinforcements that mount to the frame of the vehicle. Such a construction is configured to support up to 1996 kg of payload while only weighing 46 to 52 kg itself.

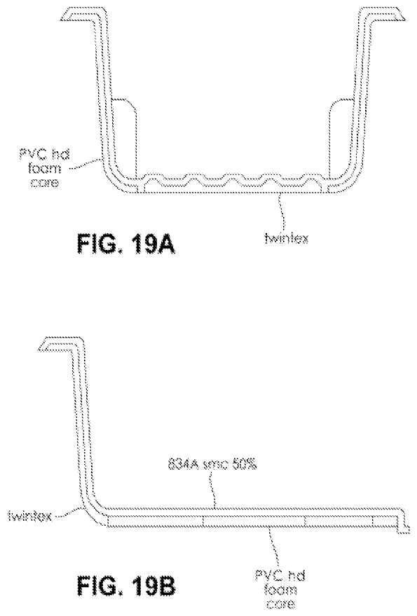

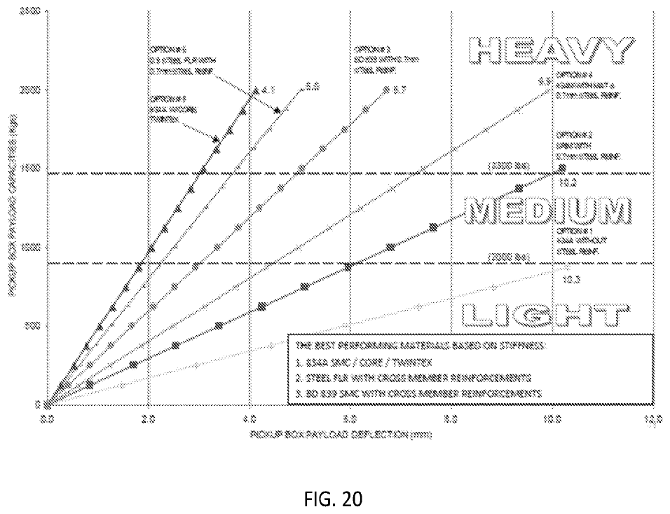

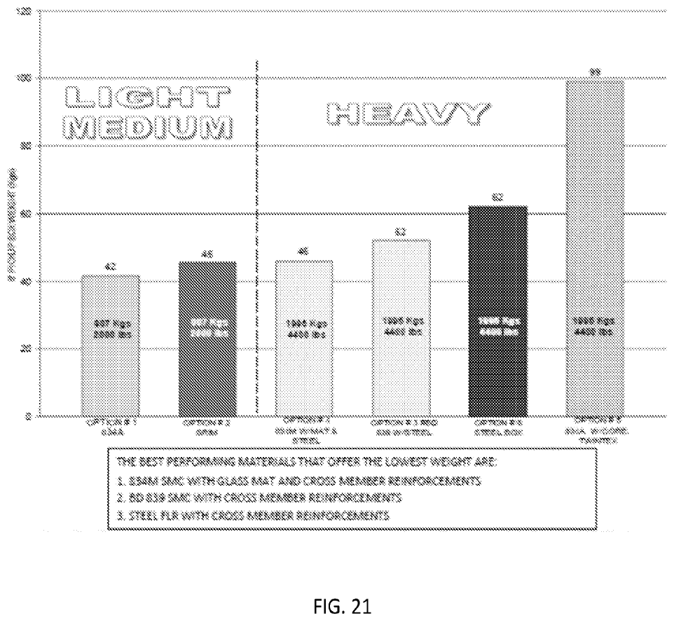

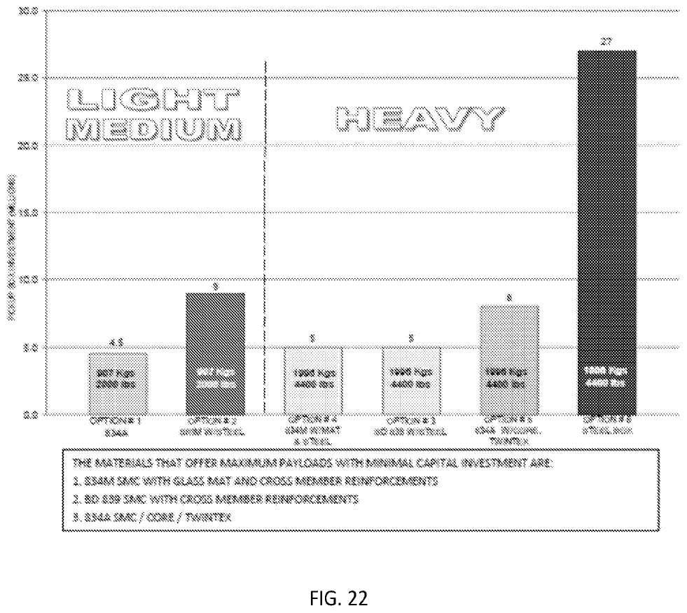

FIGS. 19A-19B show an embodiment of a heavy duty cargo construct. The cargo construct shown is formed of a double wall SMC construction bonded to a core material such as a high density PVC foam. The construct includes molded in ribs, features, and floor channels for added stiffness. This is a seamless box. Such a construction is configured to support up to 1996 kg of payload while only weighing 99.1 kg itself.

Patent documents and publications mentioned in the specification are indicative of the levels of those skilled in the art to which the invention pertains. These documents and publications are incorporated herein by reference to the same extent as if each individual document or publication was specifically and individually incorporated herein by reference.

The foregoing description is illustrative of particular embodiments of the invention but is not meant to be a limitation upon the practice thereof. The following claims, including all equivalents thereof, are intended to define the scope of the invention.

1. A vehicle cargo construct comprising:
a floor having an upper surface and an oppositely opposed lower surface;
a plurality of side wall panels extending from said floor, each of said plurality of side wall panels having an exterior surface and an oppositely opposed interior surface; and
an end wall panel extending from said floor between said plurality of side wall panels, said end wall panel having an exterior surface and an oppositely opposed interior surface;
each of said floor, said plurality of side wall panels, and said end wall panel being formed of a composite sandwich panel material comprising a core defining a plurality of pores, a surface sheet adhered to a first face of the core by a first adhesive layer, and a structural skin adhered to a second face of the core by a second adhesive layer.

2. The vehicle cargo construct of claim 1 wherein the lower surface of said floor is defined by the surface sheet of said composite sandwich panel material and the oppositely opposed upper surface of said floor is defined by the structural skin of said composite sandwich panel material.

3. The vehicle cargo construct of claim 1 wherein the exterior surface of each of said plurality of side wall panels is defined by the surface sheet of said composite sandwich panel material and the oppositely opposed interior surface of each of said plurality of side wall panels is defined by the structural skin of said composite sandwich panel material.

4. The vehicle cargo construct of claim 1 wherein the exterior surface of said end wall panel is defined by the surface sheet of said composite sandwich panel material and the oppositely opposed interior surface of said end wall panel is defined by the structural skin of said composite sandwich panel material.

5. The vehicle cargo construct of claim 1 wherein said floor, said plurality of side wall panels, and said end wall panel are integrally formed of a single piece of composite sandwich panel material.

6. The vehicle cargo construct of claim 1 further comprising a second end wall panel extending from said floor between said plurality of side wall panels, said second end wall panel having an exterior surface and an oppositely opposed interior surface.

7. The vehicle cargo construct of claim 1 further comprising a plurality of cap sections positioned along an upper edge of each of said plurality of side wall panels and said end wall panel.

8. The vehicle cargo construct of claim 1 further comprising a bed liner positioned on the upper surface of said floor.

9. The vehicle cargo construct of claim 1 wherein the core of said composite sandwich panel material is formed of a polymeric foam material.

10. The vehicle cargo construct of claim 9 wherein the polymeric foam is a closed-cell foam.

11. The vehicle cargo construct of claim 9 wherein the polymeric foam has a foam hardness values range from J to B on the pencil hardness scale.

12. The vehicle cargo construct of claim 1 wherein the core of said composite sandwich panel material includes an array having a pattern of at least one shape of: hexagonal, circular, rhomboidal, triangular, parallelogram quadrilateral, or regular quadrilateral.

13. The vehicle cargo construct of claim 1 wherein the surface sheet of said composite sandwich panel material is formed of any one of: sheet molding compound (SMC), thermoplastic sheet, dicyclopentadiene (DCPD), or overmolded polyurethane (PU).

14. The vehicle cargo construct of claim 1 wherein the surface sheet includes a filler of at least one of: glass fiber, carbon fiber, carbon nanotubes, graphene, inorganic particulate fillers, glass microspheres, low profile additives, or moisture scavengers.

15. The vehicle cargo construct of claim 1 wherein the surface sheet of said composite sandwich panel material has a thickness of from 0.5 to 3.5 mm.

16. The vehicle cargo construct of claim 1 wherein said composite sandwich panel material has a cloth intermediate between the surface sheet and the core.

17. The vehicle cargo construct of claim 1 wherein the first adhesive layer of said composite sandwich panel material contacts an interior volume of the core.

18. The vehicle cargo construct of claim 1 wherein the structural skin is formed of a fiber mat.

19. The vehicle cargo construct of claim 1 wherein said composite sandwich panel material has a fill in the pores of the core, the fill being at least one of a sound dampening foam, a fire retardant, or a phase change material.

20. The vehicle cargo construct of claim 1 wherein the surface sheet of said composite sandwich panel material and the structural skin of said composite sandwich panel material are joined together to form an edge defining a moisture resistant seal.
